(19) United States
(12) Patent Application Publication
(10) Pub. No.: US 2013/0032672 A1
(43) Pub. Date: Feb. 7, 2013

(54) FUEL DELIVERY SYSTEM AND METHOD

(71) Applicant: Stephen Fenton, Caledonia, CA (US)

(72) Inventor: Stephen Fenton, Caledonia, CA (US)

(21) Appl. No.: 13/549,820

(22) Filed: Jul. 16, 2012

Related U.S. Application Data
(60) Provisional application No. 61/515,037, filed on Aug. 4, 2011.

(51) Int. Cl. B64D 37/14

(52) U.S. Cl. 244/135 R

(57) ABSTRACT

A vehicle fuel delivery system for liquid fueled vehicles including a vehicle housing a pressure vessel for receiving, discharging and containing fuel. The vehicle fuel delivery system includes fuel lines for communicating fuel to the pressure vessel, and fuel lines for communicating fuel from the pressure vessel to a fuel delivery device. The vehicle fuel delivery system always maintaining positive fuel pressure throughout the delivery system.

This application claims priority from U.S. provisional 61/515,037 filed on Aug. 4, 2011 under the title FUEL DELIVERY SYSTEM AND METHOD by Stephen John Fenton.

### FIELD OF THE INVENTION

The present device relates to fueling systems, devices and methods and in particular relates to fueling systems for engine powered vehicles including aircraft, land vehicles and marine operated power craft.

### BACKGROUND OF THE INVENTION

Vapor lock is an unacceptable condition which can occur in liquid fuel powered engines. Most liquid fuels must be converted to a gas with vapor-like qualities within an engine's combustion cylinder in order to enable a planned, timed, burning of the fuel. It is possible under certain conditions, that the fuel transformation from liquid to gas vapor can occur before it is intended, causing technical problems to occur with the entire fuel transfer and propulsion system. This can be a problem for any liquid fueled combustion engine but is particularly a problem in aircraft which are exposed to very high G forces, large temperature variations, and large altitude variations, such as in unmanned aerial vehicles or UAV's. Therefore this specification will use a UAV as the example vehicle throughout since the technical problem can be very severe in this type of vehicle.

Most UAV systems are designed to transfer liquid gas, not vapor. The conversion of fuel from liquid to gas vapor must occur when required but not before. During fuel transfer processes from bulk ground storage through to the combustion chamber inlet in the engine, liquid fuel is susceptible to vapor formation. Once vapor is formed in a liquid fuel during transfer within a propulsion system, there is a danger that the volume of vapor will cause the carburetor or fuel injection pump to fail due to vapor lock which can ultimately cause the engine to malfunction. Unintended vapor formation can also cause other fuel system components and elements to fail with similar net result. When the volume of vapor reaches levels the propulsion system cannot manage, the vapor must be contained, broken down, eliminated or expelled before the fuel presents to the running engine. If enough quantity of unwanted vapor is in the fuel system during a UAV mission, it can result in catastrophic engine failure. This is due to vapor lock which could occur at various points in the fuel system with fuel injection or carburetion engine feed.

In addition to the original vapor problem, vapor will tend to collect at the highest point within a closed circuit fuel container system. When, for example, 1 mm to 3 mm diameter vapor bubbles are able to naturally gather, they can present to the engine in a larger bubble than the system can digest. Different liquid fuel compositions can reduce inappropriate vapor creation, however vapor occurs with common fuels as required temperature ranges and altitude limits increase.

UAV Fuel Tank System Options

The two most common fuel storage options for the UAV's include wet tanks and bladder systems. Both approaches are currently being used in the industry and have benefits and disadvantages.

Wet Tank Advantages Over the Closed Bladder System
1. Wet tank based fuel systems enable the operator to fuel by simple pouring methods.
2. Wet tank based fuel systems have inherent vapor elimination at least in the fuel storage area of the system. Any vapor in the fuel storage on the vehicle will rise to the top of the liquid and disappear.

Closed Loop Bladder Tank Advantages Over the Wet Tank System
1. Bladder tanks limit the sloshing of fuel that occurs in the wet tank system.
2. Bladder tanks enable the fuel to present to the engine regardless of attitude without the need for any sophisticated pickup systems required in the wet tank.
3. Bladders limit the possibilities of a spark causing an explosion as the ambient air does not mix with the fuel as it does in a wet tank.
4. As the bladders do not have air with the fuel, they do not require the expense of wicking anti-explosion fibrous foam.
5. Bladders can enable longer flights when the fuel level is low without as much chance of engine starvation.

To the inventor's knowledge, all UAV's using liquid fuels include at least one fuel pump with an inlet that “pulls” and an outlet that “pushes” somewhere on the air vehicle and/or on the ground station. Most liquid fueled vehicles include a “push-pull” fuel pump somewhere.

We performed extensive experimental development and in-house testing with Mogas and Avgas in fuel-recommended temperatures. We learned that vapor was being created, or was always in danger of being created whenever a negative pressure was acting on the fuel during any transfer process. This issue became more troublesome with even minor differences in transfer altitude of the fuel supply, pump and fuel tank or bladder. During fueling processes to de-fuel and fuel a miniature UAV, the vehicle, bladder, pump and supply all needed to be in a pre-specified plane. If the fuel source was below the pump by two or three feet, more negative pressure was required of the pump to get the fuel transferred. This process would cause increasing likelihood of vapor formation. There may be some systems which include portions of the concept of pushing fuel or putting positive pressure to act on a bladder, but always have a fuel pump somewhere that not only pushes, but also pulls fuel to move it in some point of the design.

Wet tanks and bladder-style fuel tanks are the two main options for UAV's today. Bladders have some technical advantage for use on UAV's as they enable better unhampered fuel flow to the engine regardless of the aircraft attitude. Bladder systems also enable the engine to run closer to empty that one would risk with a wet tank. Wet tanks also allow sloshing of the fuel that can cause foaming and bubbles to occur. The wet tanks have the chronic issue of danger from explosion due to a spark. There are requirements to use a fibrous anti-spark sponge-like material included in wet tanks to limit the explosion potential. Bladders have issues with flow capabilities when a standard push-pull fuel pump is used to get at the fuel and present it to the engine and to evacuate the fuel bladder after a mission.

The usual configuration of a bladder system in the UAV industry is to pull the fuel with the pump from the fuel bladder and then push it to the engine. Placing the push-pull pump closer to and preferably in the bladder with the fuel, will decrease vapor creation. However, that same bladder located pump would be susceptible to vapor creation if it was also used to fill the same bladder.

Fuel bladder manufacturers have been working on flow assisting internal piccolo tubes, wire wraps, mesh and other methods to ensure the fuel flow continues as the bladders are collapsing during the engine run-cycle. However, these flow assisting designs are costly, add weight, bulk and require an increased volume of fuel that must be in the bladder but will never be used to fuel the engine. The volume inside a flow assisting piccolo tube for example will hold fuel that cannot get to the engine. This is dead weight that must be flown on every mission. The best option for fuel-flow assisting bladder design is to simply to use an embossed bladder material. With embossed bladder film, no other flow assisting designs are required as the flow is inherent to the embossed film. However, as each bladder system (regardless of flow enhancing design) gets low with fuel, there is a danger of fuel starvation (reduced flow) and ever increasing in vapor creation. Various altitudes and temperature ranges all acting on the fuel bladder steadily increase vapor formation issues and can become unmanageable.

### SUMMARY OF THE INVENTION

1. A vehicle fuel delivery system for liquid fueled vehicles comprising:
a) a vehicle housing a pressure vessel for receiving, discharging and containing fuel;
b) a refueling means for pushing fuel under pressure to the pressure vessel for refueling the pressure vessel;
c) a pressure means for pushing fuel under pressure from the pressure vessel to a fuel delivery device for subsequent burning of the fuel;
d) wherein the vehicle fuel delivery system always maintains a positive fuel pressure throughout the delivery system.

Preferably wherein the pressure means includes a vehicle housed gas compressor for pushing fuel from the pressure vessel to the fuel delivery device under a head of gaseous pressure.

Preferably wherein the gas being air.

Preferably wherein the refueling means for pushing fuel under pressure to the pressure vessel for refueling the pressure vessel and for receiving fuel from the pressure vessel under pressure during defueling.

Preferably wherein the refueling means further includes a fueling station external to the vehicle for selectively pushing fuel into the pressure vessel under a head of gaseous pressure.

Preferably wherein the fueling station for selectively pushing fuel into the pressure vessel or for receiving fuel from the pressure vessel for defueling the pressure vessel.

Preferably wherein the pressure means for pushing fuel under pressure from the pressure vessel to a fuel delivery device for subsequent burning of the fuel, and for pushing fuel under pressure to the refueling means.

Preferably wherein the pressure means includes control valves for selectively pushing fuel to a fuel delivery device or to push fuel to a fueling station to defuel the pressure vessel under a head of gaseous pressure thereby always maintaining positive fuel pressure.

Preferably wherein the pressure means includes a vehicle housed gas compressor for selectively pushing fuel from the pressure vessel to the fuel delivery device under a head of gaseous pressure or to the fueling station under a head of gaseous pressure for defueling the pressure vessel.

Preferably wherein the fueling station further includes a control module and a tank assembly, the tank assembly housing fuel under a head of gaseous pressure, the fueling station for selectively pushing fuel into the pressure vessel to refuel the pressure vessel or to receive fuel from the pressure vessel into the tank assembly during defueling.

Preferably wherein the pressure vessel includes a bladder for containing the fuel, wherein the bladder expands and contracts as fuel is received and discharged.

Preferably wherein the pressure vessel includes a gas reservoir wherein the gas in the reservoir is pressurized to force fuel under a head of gaseous pressure out of the bladder.

Preferably wherein the pressure vessel includes an air port in communication with the gas reservoir for receiving and discharging gas there through.

Preferably wherein the pressure vessel includes a fuel port in communication with the bladder for receiving and discharging fuel there through.

Preferably wherein the pressure vessel includes a bladder pressure vessel for receiving, discharging and containing fuel.

Preferably wherein the pressure vessel includes a hyper G pressure vessel for receiving, discharging and containing fuel.

Preferably wherein the vehicle is an aircraft.

Preferably wherein the vehicle is an unmanned aerial vehicle.

### BRIEF DESCRIPTION OF THE DRAWINGS

With the intention of providing demonstration of the characteristics of the device or method, an example is given below, without any restrictive character whatsoever, with reference to the corresponding figures, of a preferred embodiment of the device and method as follows;

FIG. 1 schematically represents a fuel delivery system in accordance with the present concept.

FIG. 2 schematically represents fueling a plane using a fueling station in accordance with the present concept.

FIG. 3 schematically represents defueling an aircraft using a fueling station in accordance with the present concept.

FIG. 4 schematically depicts tank assemble pressurization during vehicle fueling.

FIG. 5 schematically depicts tank assembly venting for vehicle defueling.

FIG. 6 schematically depicts venting of the vehicle pressure vessel during vehicle fueling.

FIG. 7 schematically depicts pressure vessel pressurization during vehicle defueling.

### DESCRIPTION OF THE PREFERRED EMBODIMENTS

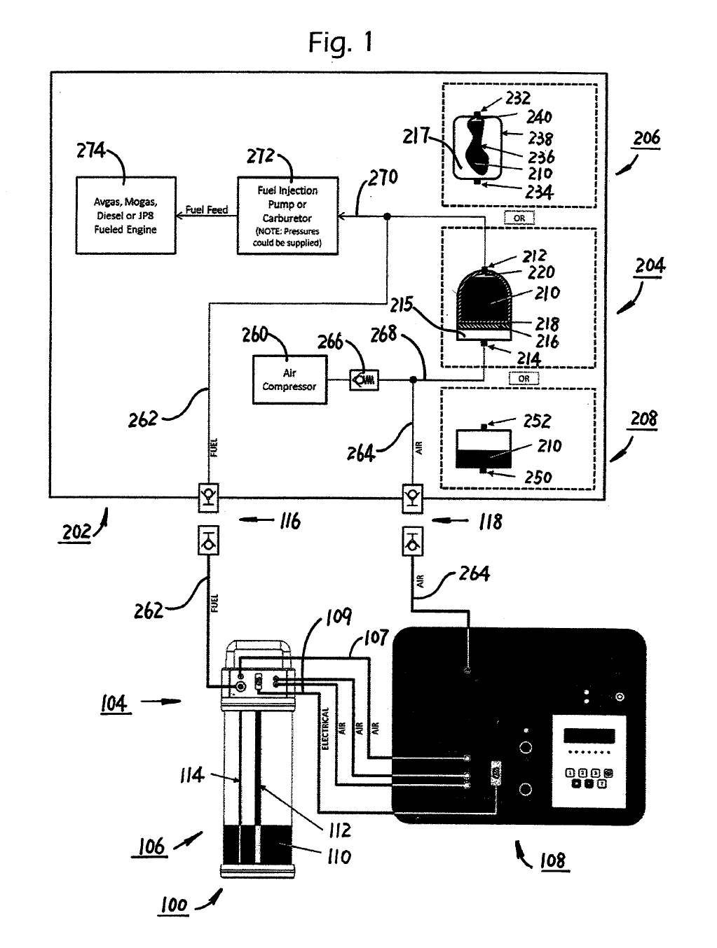

The present concept a fuel delivery system shown generally as 100 is shown in FIG. 1.

Fuel delivery system 100 includes the following major components namely vehicle fuel delivery system 202 and fueling station 104.

Referring first of all to fueling station 104 it includes the following major components namely tank assembly 106 which is connected to a control module 108.

Tank assembly 106 includes a pickup tube 114 for delivery of fuel 110 and also a level sensor 112 for measuring the level of fuel 110 within tank assembly 106.

Control module 108 is connected to tank assembly 106 with a number of air lines 107 and electrical lines 109.

The interior of control module 108 not shown includes a number of components including compressors, pressure sensors, differential pressure sensors, solenoid valves, pilot valves, manifold for distributing air and directional control valves.

The fueling station 104 is connected to the vehicle fuel delivery system 202 via a first quick connect 116 and a second quick connect 118.

First quick connect 116 communicates to vehicle fuel delivery system with a refueling fuel line 262.

Second quick connect 118 communicates to vehicle fuel delivery system 202 through a refueling air line 264.

Referring now to the vehicle fuel delivery system shown generally as 202 includes vehicle pressure vessel which may be of the type shown as hyper G pressure vessel 204 or bladder pressure vessel 206 or wet tank vessel 208. The present fuel delivery system 100 can be adapted to work with any one of the above three mentioned fuel pressure vessels.

A vehicle such as an UAV will include on board an air compressor 260, a check valve 266, a pressurized air line 268, a fuel delivery line 270, a fuel delivery device 272 and eventually fuel for combustion 274.

By way of example only fuel delivery device 272 could be a fuel injection pump or a carburetor.

Fuel for combustion 274 could be for example avgas or mogas, or diesel or JP8 fuels which are mixed with air and ready for combustion.

The reader will note that vapour is undesirable until such time as the fuel is delivered by the fuel delivery device 272 and converts it into a fuel/air mixture ready for combustion 274. Fuel for combustion 274 is normally in the form of a very fine mist or vapour, mixed with an oxidizer such as air.

Referring now back to the vehicle pressure vessels which could either be a hyper G pressure vessel 204 and/or a bladder pressure vessel 206 and/or a wet tank vessel 208.

In the case that the vehicle includes a hyper G pressure vessel 204 this vessel has a fuel port 212 located on the upper portion, an air port 214 and gas reservoir 215 located on the lower portion a gas reservoir 215, a linear piston 216 travelling within the pressure vessel 204, a bladder 218 for containing the fuel 210 and a vapour collection area 220 near the top of fuel port 212.

The reader will note that using the hyper G pressure vessel 204 any vapour which does form during any of the fueling and/or defueling operations will be collected in the vapor collection area 220 and will be quickly eliminated from the system at the very beginning or start up of the engine of the vehicle.

UAV's typically now have a bladder pressure vessel as depicted as 206 which includes fuel port 232 in communication with the interior of the fuel bladder 236 and air port 234 in communication with the space being a gas reservoir 217 between the hard or soft pressure vessel 238 and the fuel bladder 236 and a vapour collection area 240 near fuel port 232. Fuel bladder 236 houses fuel 210 squeezed or compressed by the air pressure between the hard or soft pressure vessel 238 and the bladder 236.

Most land based vehicles use a wet tank vessel 208 which includes a fuel port 250 an air port 252 wherein the wet tank vessel 208 houses fuel 210. This type of tank arrangement is normally unpressurized.

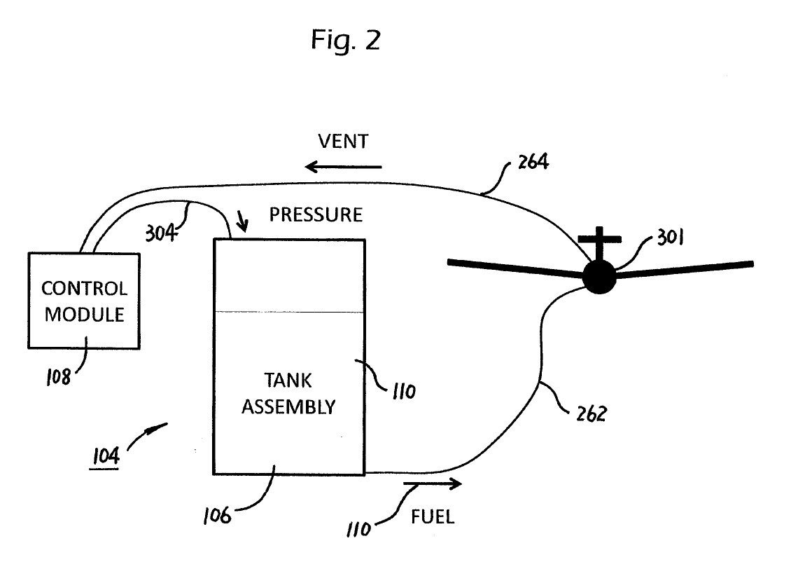

Referring now to FIG. 2 which schematically depicts the fuel flow between the fueling station 104 and aircraft schematically depicted as 301.

Referring now to FIG. 2 which is showing pressurized vehicle fueling wherein fuel 110 communicates under pressure through refueling line 262 to aircraft 301 and air flows through refueling air line 264 into control module 108 for venting or for further distribution under pressure through tank assembly air pressure line 304 for pressurizing of fuel 110 within tank assembly 106.

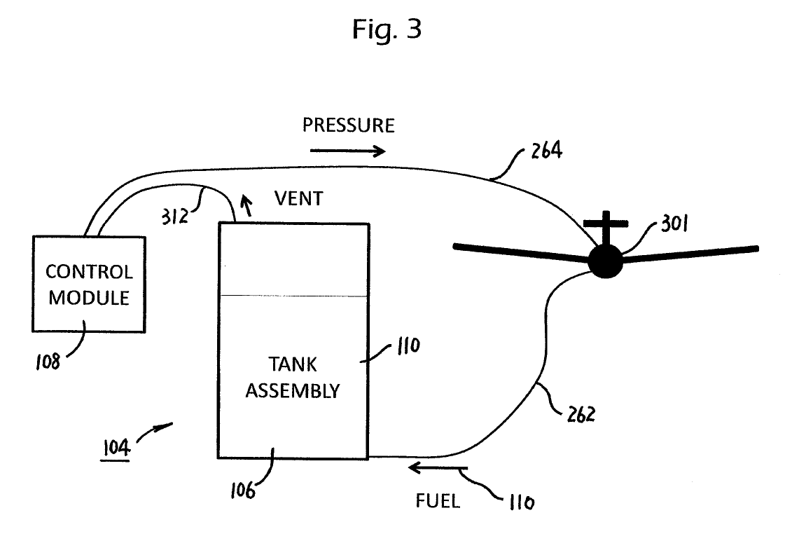

Referring now to FIG. 3 which schematically depicts defueling of an aircraft 301 using fueling station 104 wherein control module 108 produces air pressure which is communicated along refueling air lines 264 into the vehicle pressure vessel and forcibly pushes fuel 110 through refueling fuel line 262 back into tank assembly 106 wherein control module 108 provides for venting of air in tank assembly 106 through tank assembly air vent 312.

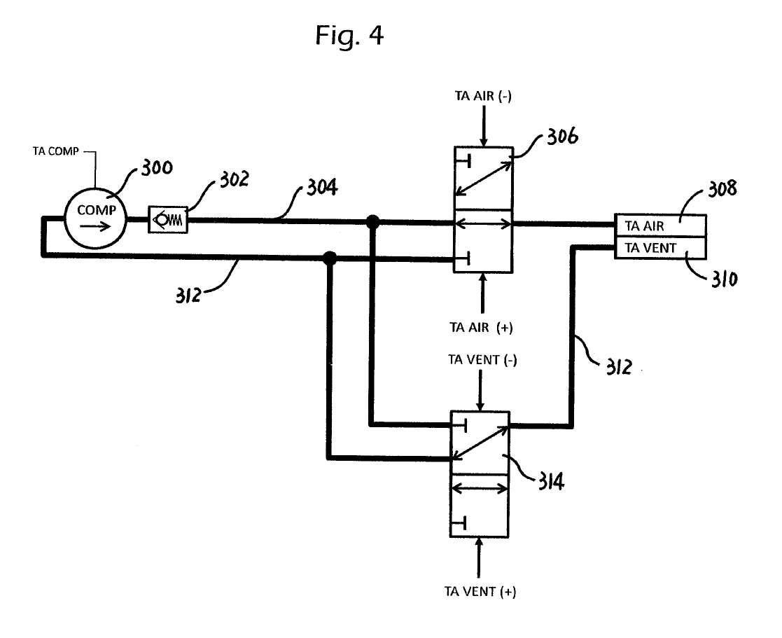

Referring now to FIG. 4 which schematically depict pressurization of the tank assembly for vehicle fueling which includes tank assembly compressor 300, check valve 302 communicating pressurized air through pressurized line 304 through first directional control valve 306 for pressurizing the tank assembly via tank assembly air 308. In addition a second directional control valve 314 ensures that air is vented to atmosphere via vent line 312 and tank assembly vent 310.

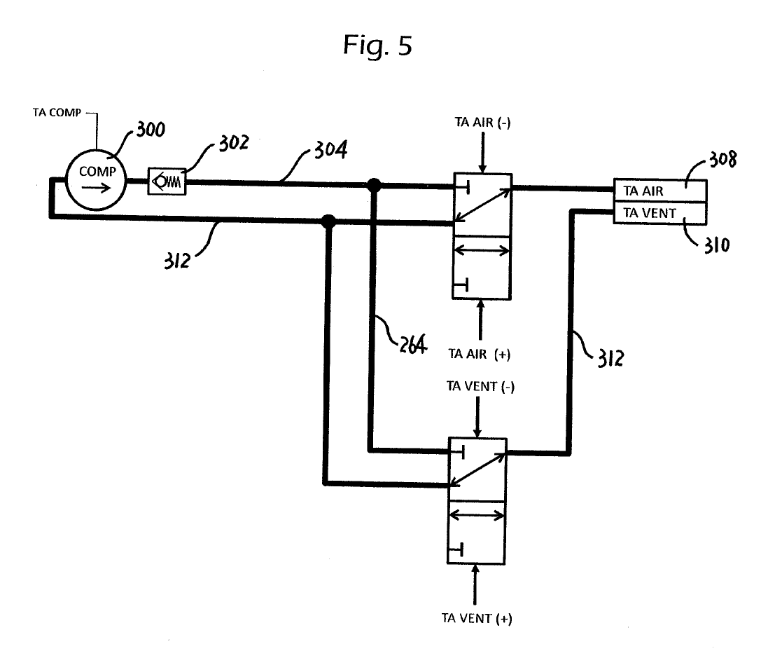

Referring now to FIG. 5 which schematically depicts a vented tank assembly for vehicle defueling in which a tank assemble compressor 300 includes a check valve 302 and a pressurized line 304 which vents to atmosphere. Tank assembly 106 in vented also to atmosphere via vent line 312 and tank assembly vent 312.

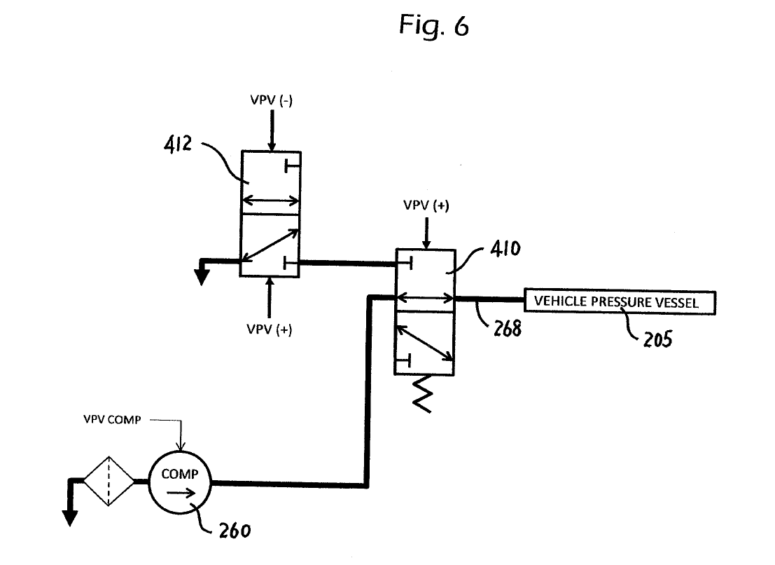

FIG. 6 schematically depicts what occurs within the vehicle pressure vessel 205 during fueling.

In FIG. 6 for example pressurized air line 268 is routed for venting through third directional control valve 410 and fourth directional control valve 412.

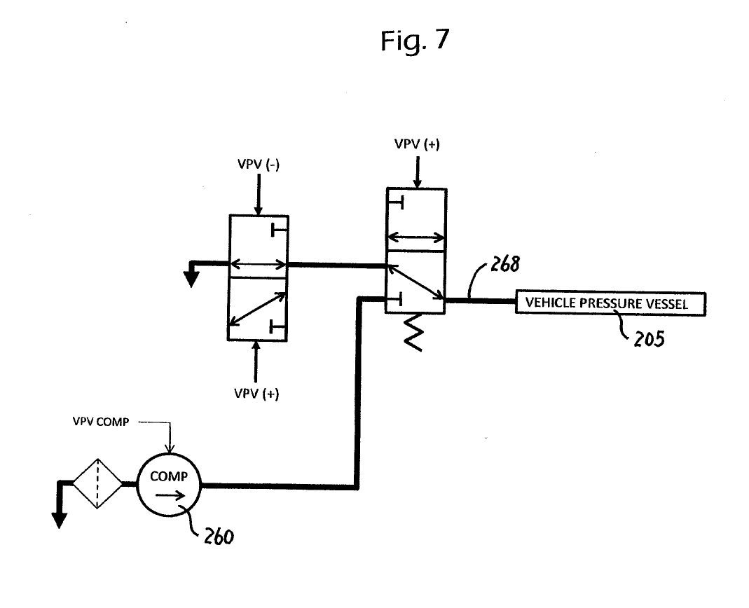

FIG. 7 schematically depicts the vehicle pressure vessel during defueling in which vehicle on-board compressor 260 supplies air under pressure to pressurized air line 268 thereby providing air pressure to vehicle pressure vessel 205 at air port 214.

The reader will note that by simply always pushing and never pulling fuel when moving it in any direction throughout the vehicle one can minimize the natural vapour creation factors in current designs. This approach is simple, less expensive in both overall design and unlocks several key advantages.

Benefits of using the current fuel delivery system 100 which includes either a bladder pressure vessel 206 or a hyper G pressure vessel 204 are as follows.

Firstly vehicle fuel delivery system 202 together with fueling station 104 which provides for fuel delivery system 100 eliminates the effects of altitude changes from acting directly against the fuel within the bladder. As a UAV flies higher altitude changes alone can cause the fuel in an unpressurized bladder to boil. This vapour is created without the need for any negative pressure pump forces assisting. The current system including a pressurized bladder and/or hyper G pressure vessel enables the UAV to fly higher and continue to run without vapour lock engine failure.

Secondly flow assisting enhancements are not required within the pressurized bladder. This saves mass weight and manufacturing expense enabling a much simpler bladder layout.

Thirdly the use of the fuel delivery system 100 allows for increased amount of fuel that can be on board due to savings in weight in other areas.

In addition a simple less expensive oversized bladder design is always under positive pressure which is not possible with a standard push/pull type of pump system. Additionally the entire fuel load is able to be used during flight and drop off of fuel to the engine will not occur until the very last drop of fuel is fed to the engine and is always sent with the same flow rate throughout.

There are other more subtle advantages to the present fuel delivery system 100 including that any vapour that is in the system would be supplied to the fuel injection or the carburetor with pressure behind it which would eliminate vapour lock as the fuel and vapour is pushed throughout the system. Any vapour take-up equipment currently required for all fuel transfer is almost entirely eliminated. Vapour is constantly and automatically being eliminated each time fuel transfers in any direction using this system. This is due to the fact that as fuel is transferred all bubbles naturally rise to the top, and are pushed out.

The current system also eliminates ground station fuel transfer pumping failure at extremely high or extremely low temperatures due to cavitation and/or fuel compatibility issues.

Fuel delivery system 100 also allows one to more quickly fuel and defuel without negative consequences. Standard current bladder system design include evacuation that requires the operator to pull the fuel out of a bladder after flight.

This process itself causes vapour to form especially when the fuel is almost fully evacuated. The amount of vapour created will change with altitude and temperature. The main reason for defueling after mission in the current system is to get any air or vapour bubbles out for the next fuel fill cycle. Unfortunately the evacuation process itself creates vapour since once the bladder is almost empty with a negative pressure pump pulling the fuel out, vapour is created more quickly than at any other stage. This vapour almost inevitably cannot be completely eliminated and becomes the first thing to go into the vehicle during the refueling process.

Finally it is easier and technically simpler to compress air to engage a mechanical spring or other mechanical device to in turn actuate a bladder and thereby move the fuel, than it is to pump fuel directly. Fuel delivery system 100 doesn't directly move fuel but creates and uses compressed air or simply releases a mechanical load to act on the fuel charge. This eliminates the need to handle the chemical effects of fuel at temperature and/or altitude.

In addition to these benefits the hyper G pressure vessel 204 also includes further benefits that are currently not available for bladder pressure vessel 206.

For example hyper G pressure vessel 204 will eliminate sloshing and balance shifting of fuel regardless of the G's during launch or flight and regardless of the amount of fuel in the tank at any time.

Secondly constant fuel feed rate is possible from the full fuel load condition to the last drop in the tank.

Thirdly there is naturally vapour elimination in mitigation through the design of the hyper G pressure vessel 204 which potentially can be used on a stand-alone basis without the fueling station 104 and on any other type of powered vehicle in the air, on the land or in the sea.

It should be apparent to persons skilled in the arts that various modifications and adaptation of this structure described above are possible without departure from the spirit of the invention the scope of which defined in the appended claim.

1. A vehicle fuel delivery system for liquid fueled vehicles comprising:
a) a vehicle housing a pressure vessel for receiving, discharging and containing fuel;
b) a refueling means for pushing fuel under pressure to the pressure vessel for refueling the pressure vessel;
c) a pressure means for pushing fuel under pressure from the pressure vessel to a fuel delivery device for subsequent burning of the fuel;
d) wherein the vehicle fuel delivery system always maintains a positive fuel pressure throughout the delivery system.

2. The vehicle fuel delivery system claimed in claim 1 wherein the pressure means includes a vehicle housed gas compressor for pushing fuel from the pressure vessel to the fuel delivery device under a head of gaseous pressure.

3. The vehicle fuel delivery system claimed in claim 2 wherein the gas being air.

4. The vehicle fuel delivery system claimed in claim 1 wherein the refueling means for pushing fuel under pressure to the pressure vessel for refueling the pressure vessel and for receiving fuel from the pressure vessel under pressure during defueling.

5. The vehicle fuel delivery system claimed in claim 1 wherein the refueling means further includes a fueling station external to the vehicle for selectively pushing fuel into the pressure vessel under a head of gaseous pressure.

6. The vehicle fuel delivery system claimed in claim 5 wherein the fueling station for selectively pushing fuel into the pressure vessel or for receiving fuel from the pressure vessel for defueling the pressure vessel.

7. The vehicle fuel delivery system claimed in claim 1 wherein the pressure means for pushing fuel under pressure from the pressure vessel to a fuel delivery device for subsequent burning of the fuel, and for pushing fuel under pressure to the refueling means.

8. The vehicle fuel delivery system claimed in claim 7 wherein the pressure means includes control valves for selectively pushing fuel to a fuel delivery device or to push fuel to a fueling station to defuel the pressure vessel under a head of gaseous pressure thereby always maintaining positive fuel pressure.

9. The vehicle fuel delivery system claimed in claim 8 wherein the pressure means includes a vehicle housed gas compressor for selectively pushing fuel from the pressure vessel to the fuel delivery device under a head of gaseous pressure or to the fueling station under a head of gaseous pressure for defueling the pressure vessel.

10. The vehicle fuel delivery system claimed in claim 5 wherein the fueling station further includes a control module and a tank assembly, the tank assembly housing fuel under a head of gaseous pressure, the fueling station for selectively pushing fuel into the pressure vessel to refuel the pressure vessel or to receive fuel from the pressure vessel into the tank assembly during defueling.

11. The vehicle fuel delivery system claimed in claim 1 wherein the pressure vessel includes a bladder for containing the fuel, wherein the bladder expands and contracts as fuel is received and discharged.

12. The vehicle fuel delivery system claimed in claim 11 wherein the pressure vessel includes a gas reservoir wherein the gas in the reservoir is pressurized to force fuel under a head of gaseous pressure out of the bladder.

13. The vehicle fuel delivery system claimed in claim 12 wherein the pressure vessel includes an air port in communication with the gas reservoir for receiving and discharging gas there through.

14. The vehicle fuel delivery system claimed in claim 13 wherein the pressure vessel includes a fuel port in communication with the bladder for receiving and discharging fuel there through.

15. The vehicle fuel delivery system claimed in claim 1 wherein the pressure vessel includes a bladder pressure vessel for receiving, discharging and containing fuel.

16. The vehicle fuel delivery system claimed in claim 1 wherein the pressure vessel includes a hyper G pressure vessel for receiving, discharging and containing fuel.

17. The vehicle fuel delivery system claimed in claim 1 wherein the vehicle is an aircraft.

18. The vehicle fuel delivery system claimed in claim 1 wherein the vehicle is an unmanned aerial vehicle.
